(19) United States
(12) Patent Application Publication
(10) Pub. No.: US 2011/0210194 A1
(43) Pub. Date: Sep. 1, 2011

(54) SHREDDER WITH SLOT GUARD

(75) Inventors: Josh DAVIS, Glenwillow, OH (US); Edgar MAURER, Glenwillow, OH (US); Jeffrey JENSEN, Glenwillow, OH (US); Bo Deng, Houjie (CN); Yin Bin Yang, Houjie (CN)

(73) Assignee: TECHTRONIC FLOOR CARE TECHNOLOGY LIMITED, Tortola (VG)

(21) Appl. No.: 12/915,931

(22) Filed: Oct. 29, 2010

Related U.S. Application Data
(60) Provisional application No. 61/256,397, filed on Oct. 30, 2009.

(51) Int. Cl. B02C 25/00

(52) U.S. Cl. 241/30; 241/37.5

(57) ABSTRACT

A shredder includes a shredder housing with a top head and a shredder mechanism receptacle. The top head has at least a first slot for receiving articles to be shredded. The shredder mechanism receptacle is connected to the top head for receiving a cutting assembly capable of shredding paper. A safety device is disposed in the shredder housing. The safety device includes a slot guard and gear system for selectively blocking the first slot.

### CROSS-REFERENCE TO RELATED APPLICATIONS

This application claims the benefit of U.S. Provisional Application No. 61/256,397, filed Oct. 30, 2009, the disclosure of which is incorporated herein by reference.

### BACKGROUND

This invention relates in general to shredders, such as paper shredders, for shredding paper documents and the like. Paper shredders, for example, typically include a housing with a cutting mechanism for cutting paper, i.e. shredding, and a container for collecting cut paper. Such shredders are typically able to shred additional items, such as CDs, credit cards, and the like. The housing typically includes a top head generally defining an opening through which papers to be shredded may pass to the cutting mechanism in a cutting assembly receptacle. Typically, the papers are then shredded by the cutting mechanism and collected in the container.

Some paper shredders include a moveable cover for the opening which may restrict access to the cutting mechanism when the shredder is not in use. The moveable cover may, for example, be a sliding cover that is manually moved, or slid, to restrict access through the opening.

One known cover system for a paper shredder includes a plate that slides across the face of the housing. The plate includes a grasp which a user may use to manually move the plate between positions covering and exposing the shredder opening.

### SUMMARY

This invention relates to a shredder, such as a paper shredder, that includes a gear driven slot guard and a method of using such a shredder.

A shredder includes a shredder housing with a top head and a shredder mechanism receptacle. The top head has at least a first slot for receiving articles to be shredded. The shredder mechanism receptacle is connected to the top head for receiving a cutting assembly capable of shredding paper. A safety device is disposed in the shredder housing. The safety device includes a slot guard and gear system for selectively blocking the first slot. The slot guard may be biased toward a position blocking the first slot. The gear system may include a toothed rack connected to the slot guard.

The shredder top head may have a second slot for receiving articles to be shredded. The second slot may be of a different configuration than the first slot. The slot guard and gear system may be capable of selectively blocking the second slot. For example, one slot may be configured for receiving paper documents, while the other slot is configured to receive article such as CDs, credit cards and the like.

The shredder top head may have a control unit including a power controller having an off state and an on state. The on state may be automatic or manual, and forward or reverse. When the slot guard is in a position to block the first slot, the power controller may be in the off state. When the power controller is in the off state, the slot guard may be in a position to block the first slot. The power controller may be coupled to the gear system such that when the power controller changes state the slot guard is moved relative to the first slot.

The shredder top head may have a key slot for a lockout key positioned such that when a lockout key moves through the key slot the gear system moves the slot guard. The state of the power controller may be related to a position of the lockout key in the key slot.

Various aspects will become apparent to those skilled in the art from the following detailed description and the accompanying drawings.

### BRIEF DESCRIPTION OF THE DRAWINGS

FIG. 1 is a perspective view of a portion of a shredder according to one embodiment.

FIG. 2 is a partially exploded bottom perspective view of the top head of the shredder housing shown in FIG. 1.

FIG. 3 is a side cross-sectional view in perspective of a portion of the top head of FIGS. 1 and 2.

FIG. 4 is a bottom view of a portion of the top head of FIGS. 1 and 2 with the slot guard in a blocking position.

FIG. 5 is enlarged view of a portion of the top head of FIG. 4.

FIG. 6 is a view similar to FIG. 4 except showing the slot guard in a non-blocking position.

FIG. 7 is enlarged view of a portion of the top head of FIG. 6.

FIG. 8 is a view similar to FIG. 6 except showing the power control switch in another position.

FIG. 9 is enlarged view of a portion of the top head of FIG. 8.

FIG. 10 is a perspective partial cross-sectional view of a portion of the top head of FIGS. 1-9.

FIG. 11 is a perspective view of a portion of a shredder according to another embodiment.

FIG. 12 is a partial side cross-sectional view of a portion of the shredder of FIG. 11 shown with the slot guard in a blocking position

FIG. 13 is a view similar to FIG. 12 except showing the slot guard in a non-blocking position.

FIG. 14 is a partial bottom perspective view of the top head of FIGS. 11-13.

FIG. 15 is an enlarged partial bottom view of a top head of yet another embodiment, shown with the slot guard in a blocking position.

FIG. 16 is a view of the top head of FIG. 15 similar to FIG. 15 except showing the slot guard in a non-blocking position.

### DETAILED DESCRIPTION

While the term “paper shredder” generally refers to a device for shredding, e.g. cutting, paper, it must be understood that as used herein the term “paper shredder” may include devices capable of shredding more than paper. For example, a “paper shredder” may be able to cut plastic articles, such as credit cards, CDs/DVDs, and the like.

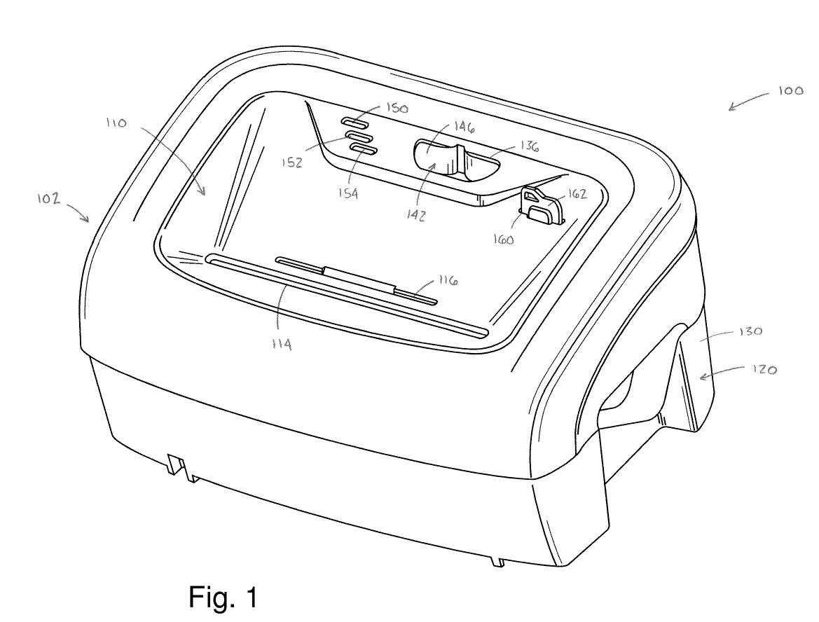

Referring now to drawings, there is shown in FIGS. 1-3 a shredder including a housing generally indicated at 100. The shredder housing 100 may be configured to sit atop a waste container or bin (not shown). The shredder housing 100 includes a top head 102. The top head 102 includes a top wall 110. The top wall 110 defines at least one generally laterally extending opening or slot for inserting material to be shredded. In the exemplary embodiment, the top wall 110 includes first and second slots 114, 116, each slot being of a selected narrowness preventing overly thick items, such as large stacks of documents, from being fed into the shredder housing 100, which could lead to jamming, relative to the capacity of the shredder. For Example, the first slot 114 may be configured to be used for paper documents and the second slot 116 may be configured to be used for more rigid articles, such as credit cards, compact discs, and the like, etc.

The shredder housing 100 includes a shredder mechanism portion 120 including shredder mechanism shredder mechanism receptacle 130 connected to the top head 102 for receiving a cutting assembly (not shown) capable of shredding paper. The cutting assembly may include an electrically powered motor (not shown) and a plurality of cutter elements or shredder blades (not shown) adapted to shred material inserted into one of the first and second slots 114, 116. The cutter elements may be mounted on a pair of parallel rotating shafts in any suitable manner. The motor may operate using electrical power to rotatably drive the shafts and the cutter elements through a conventional transmission so that the cutter elements shred articles fed therein. The shredder mechanism portion 120 also may include a sub-frame for mounting the shafts, the motor, and the transmission. The shredder mechanism portion 120 may conform with generally know operation and construction of such components. Generally, any suitable known cutting assembly may be used with the shredder housing 100.

The top head 102 includes the top wall 110 with optional sidewalls and a generally open bottom. Generally, the shredder mechanism receptacle 130 is connected to the top head 102 and has a partially open bottom wall and side walls, with an open top facing the open bottom of the top head 102. The shredder mechanism receptacle 130 may be affixed to the underside of the top head 102 by, for example, conventional fasteners. The shredder mechanism receptacle 130 has a downwardly facing opening (not shown) in the partially open bottom wall for permitting shredded articles to be discharged from the shredder mechanism portion 120 into the waste container.

With continued reference to FIGS. 1-3, the top wall 110 also has a switch recess 136 with an opening 138 therethrough the top wall 110. A power controller, such as a switch 142, which may includes a switch module (not shown), is mounted to the top wall 110 underneath the recess 136. The switch 142 may include a actuator 146, such as a manual slider that moves laterally within the recess, to change the on/off state of the switch 142. For example, the on state may include automatic or manual and forward or reverse, and the like. Also, it must be understood that the actuator 146 may include any desired interface, such as button, touch sensor, rocker, etc. Interaction with the actuator 146 may cause the switch 142 to transition between states. The switch module may inter-connect the motor and the power supply, i.e. may be hard wired, or may act to indirectly control the motor and/or power supply, i.e. soft wired. The switch 142 thus may be transitionable between on and off states by interaction with the actuator 146.

In the exemplary embodiment, the switch 142 may have a reverse position to operate the motor in a reverse manner. This may include using a reversible motor and applying a current that is of a reverse polarity relative to the on position. The ability to operate the motor in a reversing manner may be desirable in order to move the blade of the cutter assembly in a reverse direction to assist in clearing jams. In the illustrated embodiment, in an off position, the actuator 146 is located at one side, for example, the right side, of the recess 138. In a forward on position, such as auto, the actuator 146 is located at the center of the recess, and in a reverse position, the actuator 146 is located at the opposing side (the left side) of the recess. Generally, any know switch may be used for the construction and operation of the switch 142 as may be suitable for controlling the motor and/or the power supply. The shredder 100 may also any number of optional indicators, such as a container full indicator 150, an overheat indicator 152, a power indicator 154 and/or other operational indicators.

As shown in FIG. 1, the top wall 110 may further include a key slot 160 configured to receive a lock-out key 162 for releasing a switch lock (not shown). The switch lock may prevent the actuator 146 from moving the switch 142 from the off position to one of the on positions. Alternatively, the switch lock may allow the actuator 146 to move, but may disable the switch 142 from responding to changes in the actuator. In one operation, insertion of the lock-out key 162 into the key slot 160 disengages the switch lock from the actuator 146, and thus enables the switch 142 to be moved between its on and off positions. In another operation, insertion of the lock-out key 162 into the key slot 160 may trip a lock-out switch (not shown) which allows or denies power to the shredding mechanism 120. It may be that as the lock-out key 162 is removed from the key slot 160, the actuator 146 moves from an on position to the off position as necessary, or that the switch 142 is disabled, or that the lock-out key 162 may not be removed until the shredder is deactivated. In one operation, the lock-out key must first be inserted into the key slot 160 to activate the shredder mechanism; then the switch 142 can be moved to one of the on position(s) and reverse position.

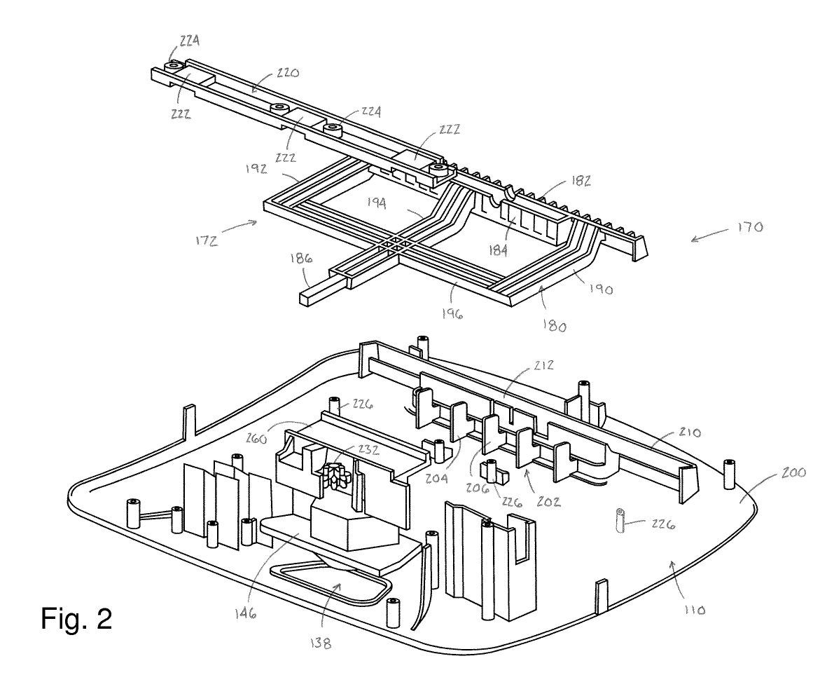

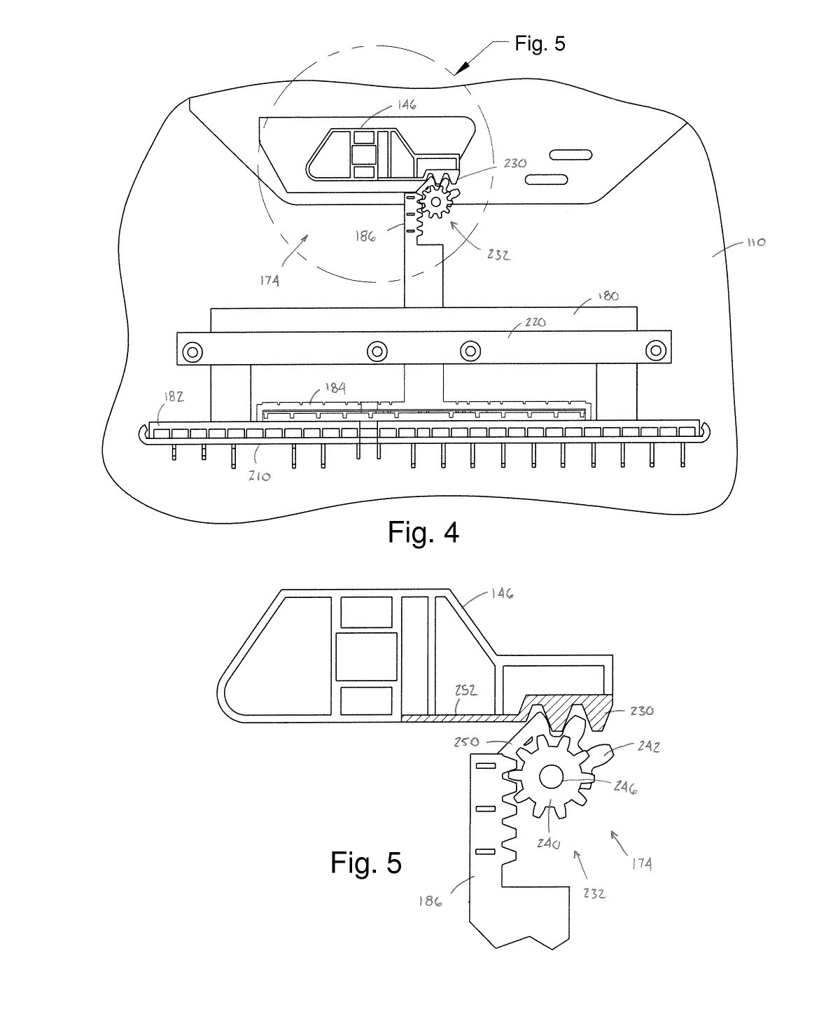

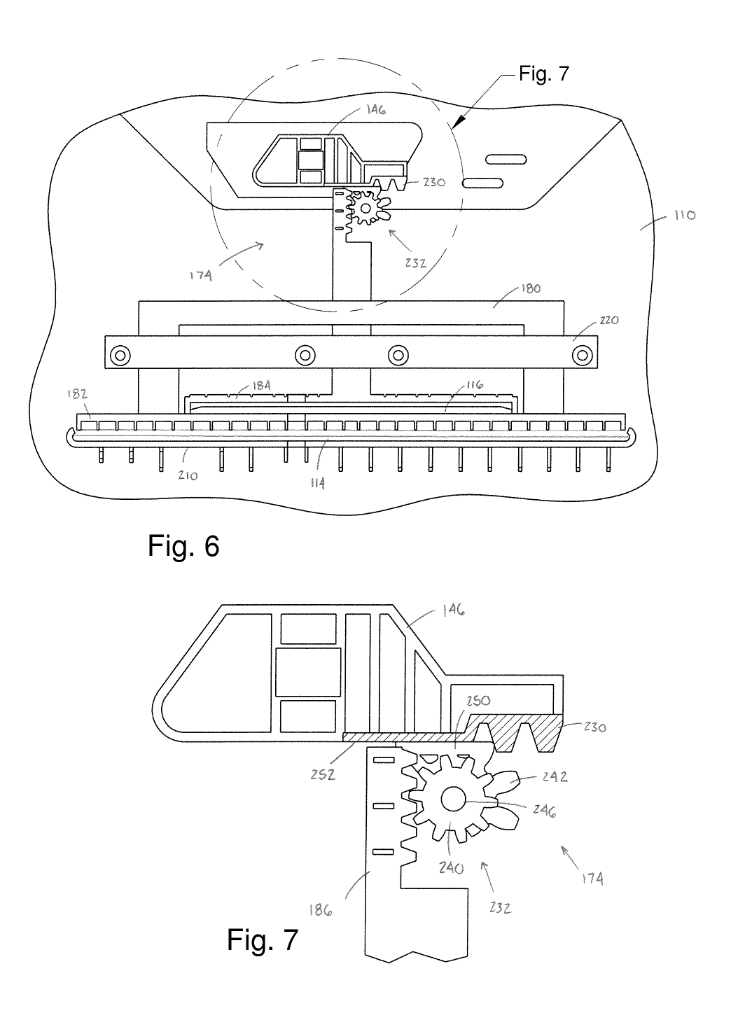

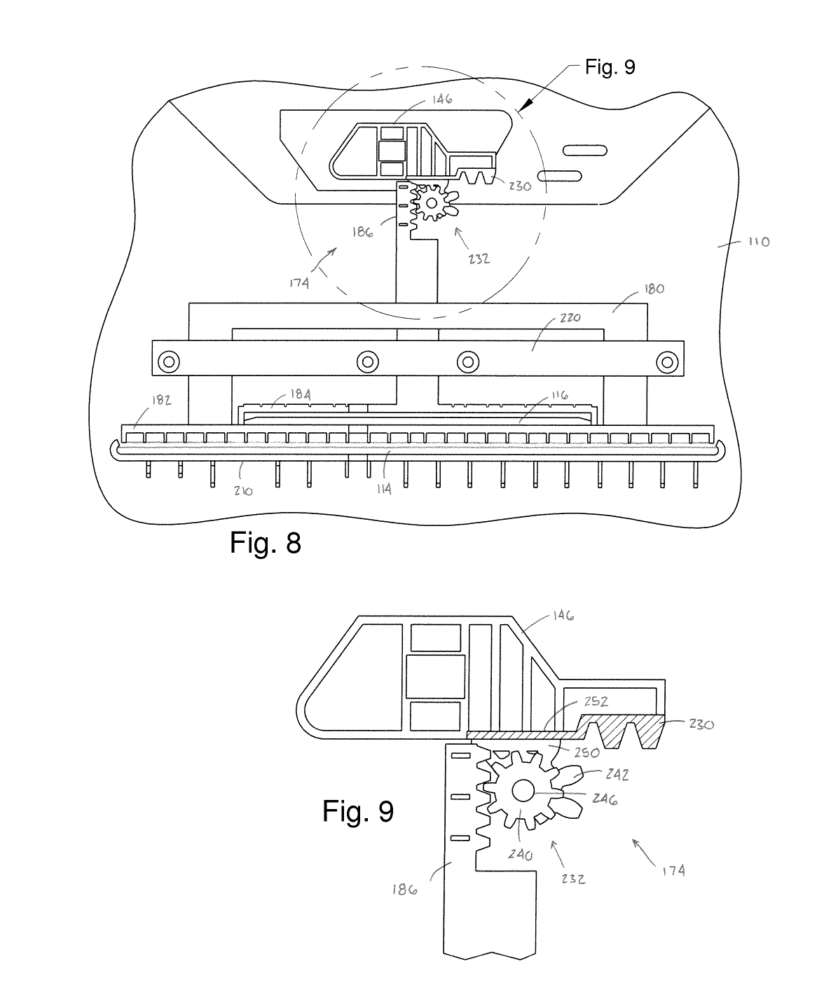

With particular reference to FIGS. 2-4, the shredder housing 100 includes a safety device 170 proximate the first and second openings 114, 116. The safety device 170 generally includes a slot guard 172 and a gear system 174. The gear system 174 is illustrated as a rack and pinion gear system. However, it must be understood that the gear system 174 may be any arrangement of gears suitable to move the slot guard 172 for selective blocking of one or both slots 114 and 116. The slot guard 172 is operable to selectively block the first and second openings 114 and 116. In the present example, as the actuator 146 moves from the off position to an on position, the gear system 174 moves the slot guard 172 from a blocking position, restricting access through at least one of the slots 114 and 116, to an un-blocking position, providing greater access through the at least one of the slots 114 and 116, see FIGS. 4 and 6. The gear system 174 positions or retains the slot guard 172 in an open position as the actuator 146 moves between the on positions, see FIGS. 6 and 8.

In this illustrated embodiment, the slot guard 172 includes a main body 180. The main body 180 has a first cover portion 182 for selectively blocking the first slot 114 and a second cover portion 184 spaced inwardly from the first cover portion 182 for selectively blocking the second slot 116. It must be understood that the main body 180 may have any suitable number of cover portions in any suitable arrangement so as to be able to block a portion of a slot, as desired. The main body 180 is configured to interact with the gear system 174 as to move the cover portions 182 and 184. In the illustrated example, the main body 180 is integrally formed with a first rack 186. It must be understood, however, that the main body may be connected to or interface with the gear system 174 in any suitable way, such as by fixing or connecting gear components to the main body 180.

In the illustrated embodiment, the first and second cover portions 182 and 184 are located at a forward end of the body 180 and the first rack portion 186 is located at a rear end of the body. The body 180 has a generally pronged, e.g. rake-like, configuration with fluted fingers including first and second end members 190, 192, a third member 194 located between the first and second members. It must be understood, however, that any number of fingers or any other suitable configuration to couple the gear system 174 to the cover portions 182 and 184. In the illustrated embodiment, the main body 180 also includes a transverse member 196 for interconnecting the first, second and third members 190, 192, and 194. More particularly, in this example, the first and second end members 190, 192 extend perpendicularly from opposed end sections of the first cover portion 182. The second cover portion 184 is located between the first and second end members 190, 192. The third member 194 extends perpendicularly from a center section of the second cover portion 184 and intersects the transverse member 196. The first rack 186 extends from an end of the third member 194 towards the actuator 146.

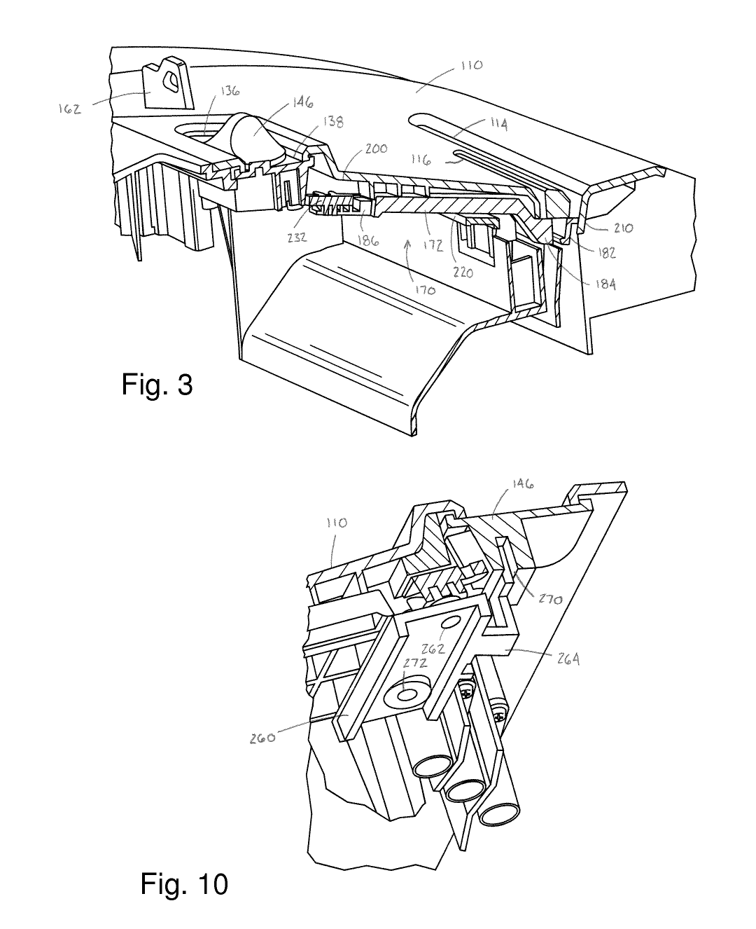

In one installation, a bottom surface 200 of the top wall 110 includes a guide portion 202 located adjacent the first and second slots 114, 116 to position the slot guard 172. As shown in FIG. 2, the guide portion 202 includes first and second tabs 204, 206 which extend outwardly from the bottom surface 200. The tabs 204, 206 may be spaced a distance which is slightly greater than a width of the third member 194. This allows the third member to be slidingly received between the tabs. The bottom surface 200 further includes an optional stop portion 210. The stop portion includes a generally U-shaped flange 212 which is located forward of the first slot 114. The flange 212 has a length slightly larger than the length of the first cover portion 182 of the slot guard 172 such that the first cover portion is at least partially received within the flange in the closed position, see FIGS. 3 and 4.

Further, a separate slot guard cover 220 may be provided to secure the slot guard 172 to the bottom surface 200 of the top wall 110. The slot guard cover 220 spans generally parallel to the transverse member 196 and includes spaced apart raised sections 222 dimensioned to slidingly receive each of the first, second and third members 190, 192, 194. To secure the blade guard cover to the bottom surface 200 of the top wall, the slot guard cover 220 includes a plurality of spaced apart openings 224 and the bottom surface includes corresponding spaced apart bosses 226. For example, conventional fasteners, such as screws, extend through the openings 224 on the blade guard cover and threadingly engage the bosses 226. Once secured to the bottom surface 200, the slot guard cover 220 retains the slot guard 172 to the top wall 110 and also allows the blade guard to slide between a blocking position and an unblocking position.

With particular reference FIGS. 4-9, the exemplary gear system 174 includes the first rack 186, a second rack 230 and a pinion gear assembly 232. As indicated previously, the first rack 186 extends from an end of the third member 194 of the main body 180 towards the actuator 146. The second rack 230 is connected to a bottom surface of the actuator 146 and is oriented generally perpendicular to the first rack 186. In the depicted exemplary embodiment, the second rack 230 is integrally formed with the actuator 146; although, this is not required. The first rack 186 is offset from the second rack 230 which allows the pinion gear assembly 232 to simultaneously engage the first and second racks as the actuator 146 is moved from the off position to one of the on position and the reverse position. It must be understood however, that the gear system 174 may have any configuration to gearingly drive the slot guard 172. For example, a linear toothed rack may be driven by any suitable moving gear, such as a motor driven rotatable gear or a linear actuator with a mating linear toothed rack, or any other suitable configuration.

With particular reference to FIGS. 5, 7 and 9, the pinion gear assembly 232 includes a first gear part 240 and a second gear part 242. The first and second gear parts are rotatably received on a common hub 246 such that the first gear part 240 is located radially above the second gear part 242. The first gear part 240 is configured to engage the first rack 186. The second gear part 242 is configured to engage the second rack 230. More specifically, in one operation, as the actuator 146 is moved, the second rack 230 engages the second gear part 242 causing the first and second gear parts to rotate. As the first gear part 240 rotates, it engages the first rack 186 and the slot guard 172 is moved from a blocking position (e.g. FIG. 4) to an unblocking position (e.g. FIG. 6). As the actuator 146 is further moved between on positions, a flat portion 250 of the second gear part 242 slideably engages a corresponding flat portion 252 of the second rack 230. The flat portions 250, 252 slide against each other as the actuator 146 is moved between on positions (e.g. FIGS. 7, 9). The flat portion 250 may thus hold the slot guard 172 in its unblocking position as the actuator 146 is moved between on positions.

As best shown in FIG. 10, a separate gear cover 260 is provided to retain the pinion gear assembly 232 to the bottom surface 200 of the top wall 110. The cover 260 is configured to retain the pinion gear assembly 232 and/or the actuator 146 to the top wall 110. Particularly, in the present embodiment, as shown in FIG. 10, the cover 260 includes an aperture 262 dimensioned to receive and end of the hub 246 of the pinion gear assembly. An opposed end of the hub 246 may be received in a corresponding aperture (not visible) located on the bottom surface 200. A generally L-shaped arm 264 extends outwardly from the cover 260. An end section of the arm is slidingly received in a channel 270 located on an underside of the actuator 146. This connection between the arm 264 and the actuator 146 allows the button to slide within the recess 136 between the off, on and reverse positions. To secure the cover 260 to the bottom surface 200, the cover includes an opening 272 and the bottom surface includes a corresponding boss (not shown). For example, a conventional fastener, such as a screw, may be received in the opening and threadingly engages the boss.

In one operation of the shredder, the lock-out key 162 is first placed in the key slot 160. This allows the actuator 146 to move between the off and on positions. The actuator 146 is moved to one of the on positions, which, in turn, moves the slot guard 172 via the gear system 174. Particularly, as the actuator 146 is moved from the off position to the first on position, the second rack 242 engages the second gear part 242 which rotates the pinion gear assembly 232. The first gear part 240 engages the first rack 186. As the first gear part rotates, the slot guard 172 moves from a blocking position to an unblocking position. This allows for articles to be received in one of the first and second slots 114 and 116 to be shredded by the cutting assembly. For example, if a jam occurs during the shredding process, in one operation, the actuator 146 may be moved from the first on position, e.g. forward, to the second on position, e.g. reverse. Movement to the reverse position moves the flat portion 250 of the second gear part 242 into engagement with the flat portion 252 of the second rack 230. The flat portion 250 thus holds the slot guard 172 in an unblocking position as the actuator 146 is moved between the on positions. To turn the shredder housing 100 off, the actuator 146 may be moved from one of the on positions to the off position. As the actuator 146 slides to the off position, the second rack 230 reengages the second gear part 242 and the first gear part 240 reengages the first rack 186. This moves the slot guard 172 back to a blocking position.

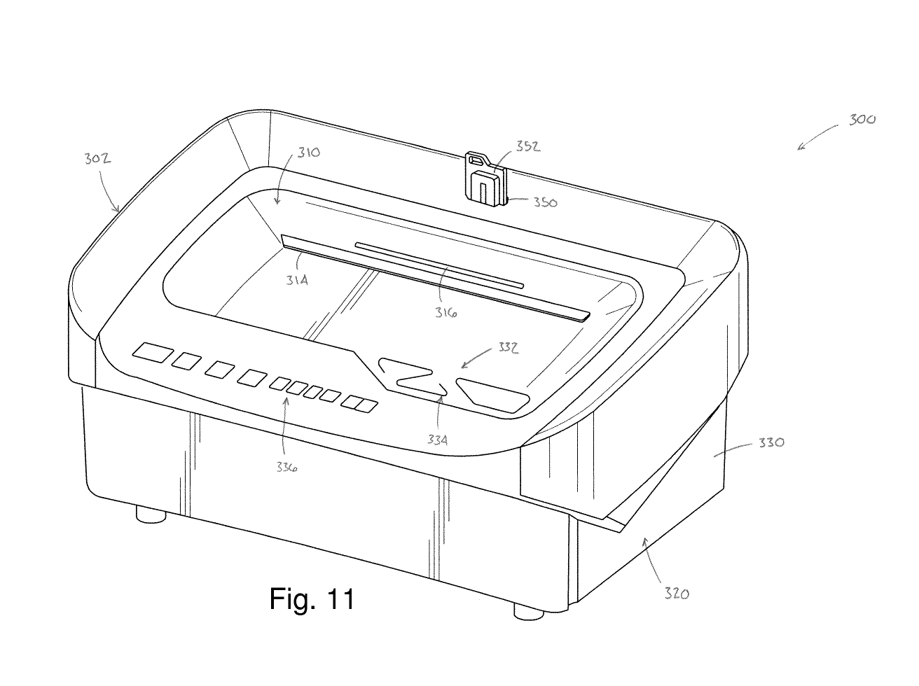

FIGS. 11-14 and FIGS. 15-16 illustrate two other exemplary embodiments of a shredder housing 300 having a safety device. Referring to FIG. 11, similar to shredder housing 100, the shredder housing 300 comprises a top head 302 configured to sit atop a waste container or bin (not shown). The shredder top head 302 includes a top wall 310. The top wall 310 includes first and second laterally extending openings or slots 314, 316 for inserting material to be shredded. The shredder housing 300 further includes a shredder mechanism portion 320 adapted to shred materials inserted into one of the first and second slots. A cutting assembly is housed in a shredder mechanism receptacle 330 which is affixed to the underside of the top wall 310 via, for example, conventional fasteners.

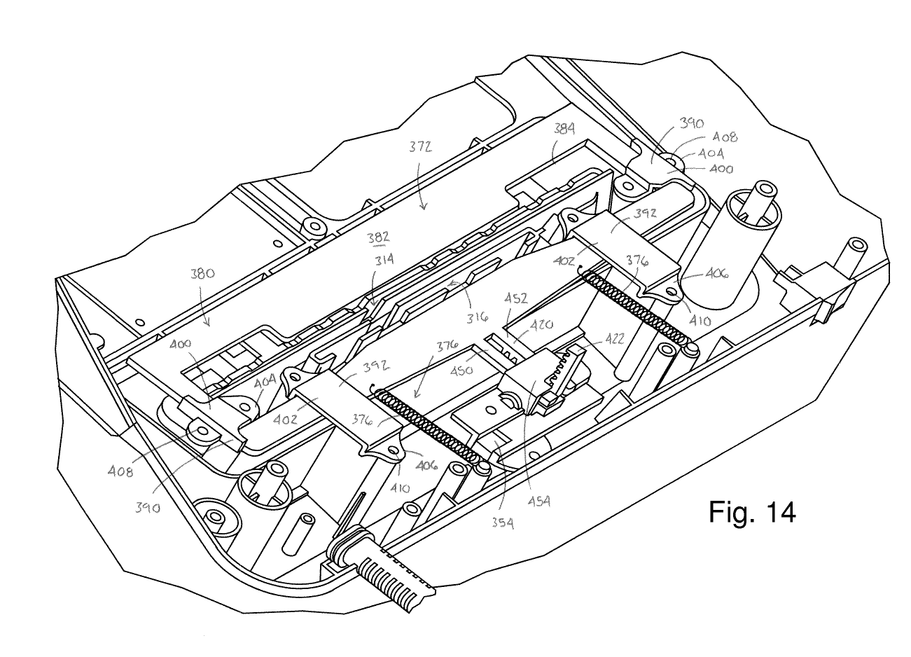

The top wall 310 includes an optional display panel 332 having, for example, power and direction control buttons 334 and an optional light display 336. The power and direction control buttons turn power on to the shredder and operate the shredder in one on position, such as auto or reverse. The light display may display the operational status of the shredder and may include a jamming indicator, an overheat indicator and/or other operational indicators. The top wall 310 further includes a third opening or key slot 350 configured to receive a lock-out key 352. According to one exemplary operation, insertion of the lock-out key 352 into the key slot 350 may trip a power switch 354, see FIG. 14, which turns power on to the shredder housing 300. In one operation, the lock-out key 352 must be inserted into the key slot 350 to activate the cutting assembly in the shredder mechanism portion 320.

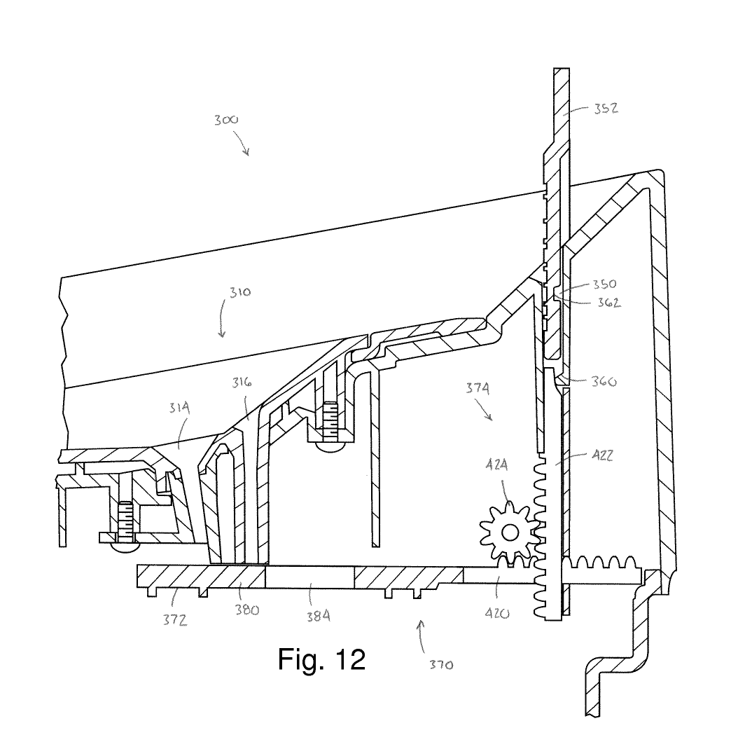

With specific reference FIGS. 12-14, the shredder housing 300 includes a safety device 370 positioned at the first and second openings 314 and 316. The safety protection device 370 generally includes a slot guard 372 and a gear system 374, the illustrated gear system 374 is depicted as a rack and pinion gear system, although such is not required. The slot guard 372 selectively blocks, at least partially, the first and second openings 314 and 316. The gear system 374 may operate to move and retain the slot guard 372 in an unblocking position, e.g. FIG. 14, as the lock-out key 352 is inserted into the key slot 350. An optional biasing member 376 functions to move the slot guard 372 from the unblocking position to a blocking position as the lock-out key 352 is removed from the key slot 350.

The slot guard 372 may include a main body 380 having a cover portion 382 and an elongated opening 384. The cover portion 382 is located at a forward end of the main body 380 for selectively blocking the first and second openings 314 and 316. The elongated opening 384 may at least partially align with at least one of the first and second opening 314 and 316 when the slot guard 372 is in an unblocking position. As shown in FIG. 14, to slidingly mount the slot guard 372 to the top wall 310, first and second guard covers 390 and 392 are optionally provided. In this exemplary embodiment, the first guard covers 390 are secured over opposed ends of the slot guard 372. The second guard covers 392 are secured over a rear end of the blade guard. Each of the first and second guard covers 390 and 392 is generally U-shaped and includes a raised portion 402 and 404 which allows a portion of the slot guard 372 to slide underneath the guard cover. Tabs 404 and 406 are optionally provided on the first and second guard covers 390 and 392. The tabs 404 and 406 have openings 408 and 410 which align with bosses extending from the bottom surface of the top wall 310. For example, conventional fasteners, such as screws, may extend through the openings and threadingly engage the bosses. Once secured to the bottom surface of the top wall, the slot guard 372 may selectively slide within the raised portions 400 and 402 of the first and seconds guard covers 390 and 392.

With specific reference to FIGS. 12-14, the gear system 374 includes a first rack 420, a second rack 422 and a gear 424 positioned above the first rack. The first rack 420 extends outwardly from the slot guard 372 towards the main power switch 354, which is, in one embodiment, controlled by the lock-out key 352. It must be understood that the gear system may have any configuration to moveably drive the slot guard 372 and the lock-out key may directly or indirectly activate/deactivate the main power for the shredder. The first rack 422 includes spaced apart first and second rack portions 450, 452, each rack portion being engageable by the gear 424. The second rack 422 extends generally perpendicular to the first rack and is movable between the first and second rack portions 450, 452. An upper portion of the second rack 422 is at least partially located within the third slot 350 such that the second rack is engaged by the lock-out key 352 as the lock-out key is being inserted into the third slot. A bottom portion of the second rack 422 is engaged by the gear 424. In one arrangement, a separate guard cover 454 retains the first rack 420, the power switch 354 and the gear 424 to the bottom surface of the top wall 310.

In one use, the lock-out key 352 may be inserted into the third slot 350. This may then enable the power switch 354 which turns may provide power in the shredder housing 300. The lock-out key 352 may engage the top portion of the second rack 422 and pushes the second rack 422 downwardly. As the second rack 422 moves downwardly, the bottom portion of the second rack 422 may engage the gear 424 which, in turn, causes the gear 424 to rotate. The gear 424 may then engage the first rack 420, which, thus, moves the first rack 420 away from the second rack 422.

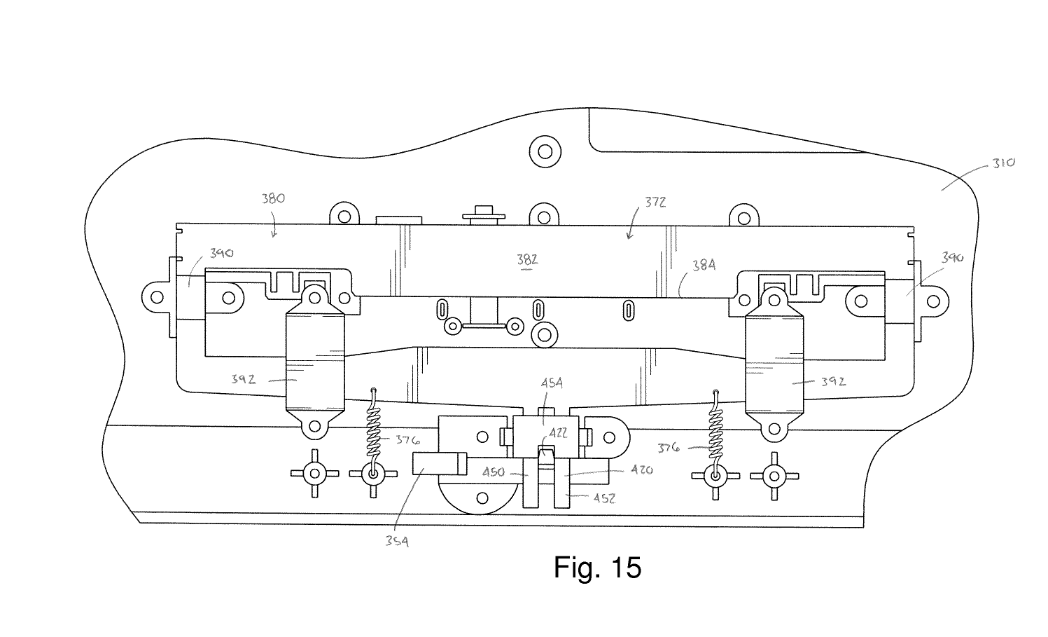

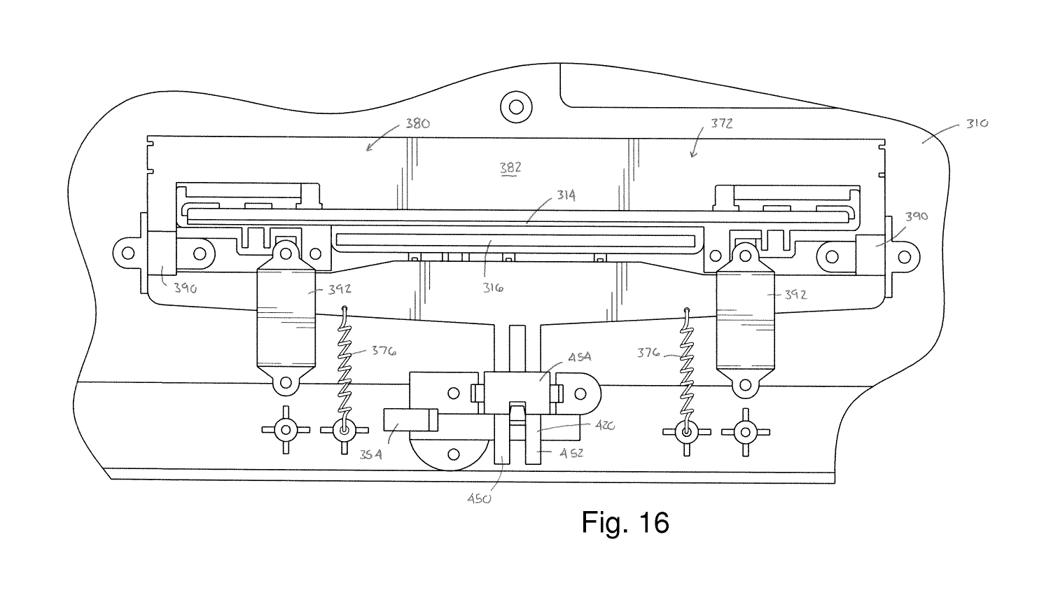

With specific reference to FIGS. 15 and 16 and the embodiment shown therein, the first rack 420 may move the blade guard 272 from a blocking position to an unblocking position thus providing greater access through at least one of the first and second slots 314 and 316. Similarly as previously described, biasing members 376, such as springs, may be provided for automatically moving the guard cover 372 back to its blocking position upon the removal of the lock-out key 352 from the key slot 350. More particularly, as the slot guard 372 moves from the blocking position to the unblocking position, the biasing members 376 are stretched. As the lock-out key 352 is removed, the biasing members 376 contract to their original condition causing the slot guard 372 to move from the unblocking position to the blocking position. When the lock-out key 352 is removed, the slot guard 372 at least partially blocks at least one of the first and second slots 314 and 316 and is held in the blocking position by the biasing members 376.

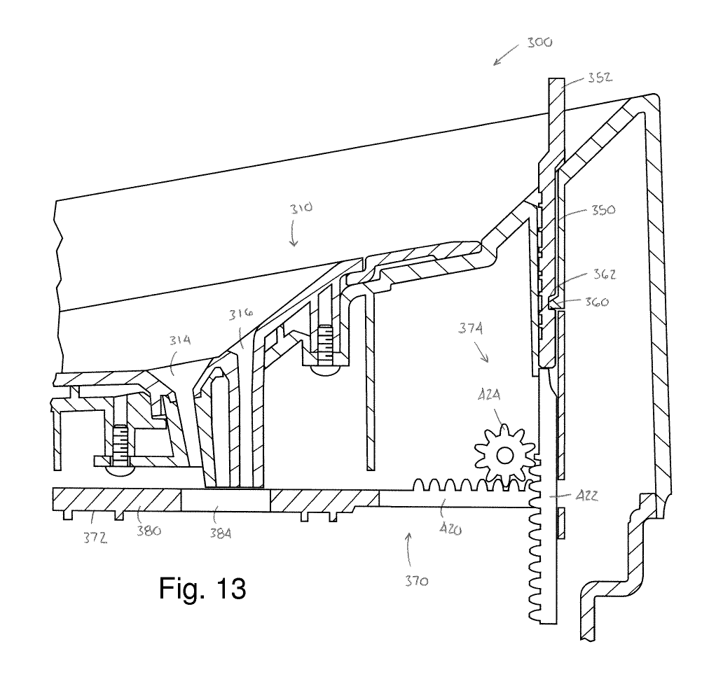

As shown in FIGS. 12 and 13, a lock tab 360 may be provided in the key slot 350. The lock-out key 352 may include a corresponding recess 362 for receiving the lock tab 360. As the lock-out key 352 is inserted into the key slot 350, the recess 362 in the lock-out key 352 may align with the lock tab 360. This may retain the lock-out key 352 in the key slot 350.

While principles and modes of operation have been explained and illustrated with regard to particular embodiments, it must be understood, however, that this may be practiced otherwise than as specifically explained and illustrated without departing from its spirit or scope.

What is claimed is:

1. A shredder system comprising:
a shredder housing including a top head having a first slot for receiving articles to be shredded and a shredder mechanism receptacle connected to the top head for receiving a cutting assembly capable of shredding paper, and
a safety device disposed in the shredder housing including a slot guard and gear system for selectively blocking the first slot.

2. The shredder system of claim 1 where said top head further has a second slot for receiving article to be shredded, the second slot being of a different configuration than the first slot, and the slot guard and gear system capable of selectively blocking the second slot.

3. The shredder system of claim 1 where said top head further has a control unit including a power controller having an off state and an on state, wherein when the slot guard is in a position to block the first slot, the power controller is in the off state.

4. The shredder system of claim 1 where said top head further has a control unit including a power controller having an off state and an on state, wherein when the power controller is in the off state, the slot guard is in a position to block the first slot.

5. The shredder system of claim 1 where said top head further has a control unit including a power controller having an off state and an on state, where the power controller is coupled to the gear system such that when the power controller changes state the slot guard is moved relative to the first slot.

6. The shredder system of claim 1 where said top head further has a key slot for a lockout key positioned such that when a lockout key moves through the key slot the gear system moves the slot guard.

7. The shredder system of claim 6 where said top head further has a control unit including a power controller having an off state and an on state, wherein the state of the power controller is related to a position of the lockout key in the key slot.

8. The shredder system of claim 1 where slot guard is biased toward a position blocking the first slot.

9. The shredder system of claim 1 where the gear system includes a toothed rack connected to the slot guard.

10. A paper shredder comprising:
a shredder housing including a top head having a first slot for receiving articles to be shredded and a shredder mechanism receptacle connected to the top head for receiving a cutting assembly capable of shredding paper, and
a safety device disposed in the shredder housing including a slot guard for selectively blocking the first slot and a means for positioning said slot guard.

11. The paper shredder of claim 10 where said top head further has a second slot for receiving article to be shredded, the second slot being of a different configuration than the first slot, and the slot guard capable of selectively blocking the second slot.

12. The paper shredder of claim 10 where said top head further has a control unit including a power controller having an off state and an on state, wherein said means for positioning is activated when the power controller changes state.

13. The paper shredder of claim 10 where said top head further has a control unit including a power controller having an off state and an on state, wherein when the power controller changes state said means for positioning is activated.

14. The paper shredder of claim 10 where said top head further has a key slot for a lockout key positioned such that when a lockout key moves through the key slot the means for positioning moves the slot guard.

15. The paper shredder of claim 1 where slot guard is biased toward a position blocking the first slot.

16. A method of shredding comprising the steps of:
a. providing a shredder including a shredder housing with a top head having a first slot for receiving articles to be shredded and a shredder mechanism receptacle connected to the top head for receiving a cutting assembly capable of shredding paper, and a safety device disposed in the shredder housing including a slot guard and gear system for selectively blocking the first slot.
b. moving the slot guard with the gear system to unblock the first slot in the top head,
c. inserting material to be shredded through the first slot in the top head, and
d. moving the slot guard with the gear system to block the first slot in the top head.

17. The method of claim 16 where the top head further has a second slot for receiving article to be shredded, the second slot being of a different configuration than the first slot, and the moving in step b. includes unblocking the second slot and the moving in step d. includes blocking the second slot.

18. The method of claim 16 where the top head further has a control unit including a power controller having an off state and an on state, and where step b. further includes changing the state of the power controller to an on state and step d. further includes changing the state of the power controller to the off state.

19. The method of claim 16 where the top head further has a key slot for a lockout key and the moving in step b. and the moving in step c. are activated when a lockout key moves through the key slot.
